(19) United States
(12) Patent Application Publication
(10) Pub. No.: US 2024/0296384 A1
(43) Pub. Date: Sep. 5, 2024

(54) System, Method, and Computer Program Product for Segmentation Using Knowledge Transfer Based Machine Learning Techniques

(71) Applicant: Visa International Service Association, San Francisco, CA (US)

(72) Inventors: Sheng Wang, Austin, TX (US); Yiwei Cai, Mercer Island, WA (US); Xi Kan, Austin, TX (US); Pei Yang, Austin, TX (US); Peng Wu, College Station, TX (US)

(21) Appl. No.: 18/578,406

(22) PCT Filed: Jul. 14, 2022
(86) PCT No.: PCT/US22/37106

§ 371 Date: Jan. 11, 2024

Related U.S. Application Data
(60) Provisional application No. 63/221,671, filed on Jul. 14, 2021.

(51) Int. Cl. G06N 20/00

(52) U.S. Cl. CPC G06N 20/00

(57) ABSTRACT

Provided is a system for segmenting large scale datasets according to machine learning models based on transfer learning that includes at least one processor programmed or configured to train a base machine learning model using a training dataset to generate a trained machine learning model, evaluate the trained machine learning model using an evaluation dataset, wherein, when evaluating the trained machine learning model using the evaluation dataset, the at least one processor is programmed or configured to generate a confidence score for each data instance of the evaluation dataset with the trained machine learning model, augment the evaluation dataset based on the confidence score for each data instance of the evaluation dataset to generate an augmented evaluation dataset, and retrain the trained machine learning model using the augmented evaluation dataset to generate a final machine learning model. Methods and computer program products are also provided.

### CROSS REFERENCE TO RELATED APPLICATIONS

This application is the United States national phase of International Application No. PCT/US2022/037106 filed Jul. 14, 2022, and claims priority to U.S. Provisional Patent Application No. 63/221,671, filed Jul. 14, 2021, which are incorporated herein by reference in their entirety.

### BACKGROUND

### 1. Technical Field

The present disclosure relates generally to systems, devices, products, apparatus, and methods for data and model segmentation and, in one particular embodiment, to a system, method, and computer program product for segmenting large scale datasets according to machine learning models based on transfer learning.

### 2. Technical Considerations

Machine learning may refer to a field of computer science that uses statistical techniques to provide a computer system with the ability to learn (e.g., to progressively improve performance of) a task with data without the computer system being explicitly programmed to perform the task. In some instances, a machine learning model may be developed for a set of data so that the machine learning model may perform a task (e.g., a task associated with a prediction) with regard to the set of data.

In some instances, a machine learning model, such as a predictive machine learning model, may be used to make a prediction regarding a risk or an opportunity based on a large amount of data (e.g., a large scale dataset). A predictive machine learning model may be used to analyze a relationship between the performance of a unit based on a large scale dataset associated with the unit and one or more known features of the unit. The objective of the predictive machine learning model may be to assess the likelihood that a similar unit will exhibit the same or similar performance as the unit. In order to generate the predictive machine learning model, the large scale dataset may be segmented so that the predictive machine learning model may be trained on data that is appropriate.

When building a machine learning model on a large scale dataset, the large scale dataset may be divided into groups, which may be referred to as sub-populations of the dataset, and individual models may be trained for each sub-population. In some instances, the techniques involved in dividing the dataset into groups may rely on heuristics to divide the dataset. For example, the techniques may involve dividing the dataset into groups based on aspects of the dataset, such as a geographic region, where an event took place and/or other specific characteristics of an event.

However, such techniques may require a lot of resources, including subject matter expertise along with availability and access to the expertise. Further, these techniques may provide a biased result. For example, where heuristics are involved, there may be different results based on different sources of subject matter expertise. Furthermore, the techniques involved may be static, which makes the techniques hard to adapt to dynamics and evolving patterns of the dataset and a level of segmentation may also be fixed.

### SUMMARY

Accordingly, provided are improved systems, devices, products, apparatus, and/or methods for segmenting large scale datasets according to machine learning models based on transfer learning.

According to non-limiting embodiments, provided is a system including at least one processor programmed or configured to train a base machine learning model using a training dataset to generate a trained machine learning model, the base machine learning model is configured to provide a confidence score, the confidence score is a score indicating how sure it is that a machine learning production model will provide a correct prediction of an input at inference. The at least one processor is further programmed or configured to evaluate the trained machine learning model using an evaluation dataset, wherein when evaluating the trained machine learning model using the evaluation dataset, the at least one processor is programmed or configured to generate a confidence score for each data instance of the evaluation dataset with the trained machine learning model. The at least one processor is further programmed or configured to augment the evaluation dataset based on the confidence score for each data instance of the evaluation dataset to generate an augmented evaluation dataset and retrain the trained machine learning model using the augmented evaluation dataset to generate a final machine learning model.

In some non-limiting embodiments or aspects, the system further includes receiving an input, determining a confidence score for the input and selecting a machine learning production model of a plurality of machine learning production models based on the confidence score for the input.

In some non-limiting embodiments or aspects, selecting the machine learning production model of the plurality of machine learning production models may include comparing the confidence score of the input to a plurality of threshold values, determining whether the confidence score of the input satisfies one or more of the plurality of threshold values, and selecting the machine learning production model of the plurality of machine learning production models based on determining that the confidence score satisfies one or more of the plurality of threshold values.

In some non-limiting embodiments or aspects, selecting the machine learning production model of the plurality of machine learning production models may include performing a distribution analysis based on the confidence score of the input and selecting the machine learning production model of the plurality of machine learning production models based on the distribution analysis.

According to non-limiting embodiments or aspects, provided is a computer program product including at least one non-transitory computer readable medium including one or more instructions that, when executed by at least one processor, cause the at least one processor to train a base machine learning model using a training dataset to generate a trained machine learning model, the base machine learning model is configured to provide a confidence score, the confidence score is a score indicating how sure it is that a machine learning production model will provide a correct prediction of an input at inference. The one or more instructions further cause the at least one processor to evaluate the trained machine learning model using an evaluation dataset. The one or more instructions that cause the at least one processor to evaluate the trained machine learning model using the evaluation dataset cause the at least one processor to generate a confidence score for each data instance of the evaluation dataset with the trained machine learning model, augment the evaluation dataset based on the confidence score for each data instance of the evaluation dataset to generate an augmented evaluation dataset and retrain the trained machine learning model using the augmented evaluation dataset to generate a final machine learning model.

In some non-limiting embodiments or aspects, each data instance of the evaluation dataset may include at least one feature value and a ground truth value. In some non-limiting embodiments or aspects, the one or more instructions that cause the at least one processor to generate the confidence score for each data instance of the evaluation dataset with the trained machine learning model cause the at least one processor to determine a score of the trained machine learning model for each data instance of the evaluation dataset and calculate the confidence score for each data instance of the evaluation dataset based on the score of the trained machine learning model for each data instance of the evaluation dataset and the ground truth value for each data instance of the evaluation dataset.

In some non-limiting embodiments or aspects, the one or more instructions that cause the at least one processor to calculate the confidence score for each data instance of the evaluation dataset cause the at least one processor to calculate an absolute value of a difference of the ground truth value and the score of the trained machine learning model and subtract the absolute value of a difference of the ground truth value and the score of the trained machine learning model from 1 to provide the confidence score.

In some non-limiting embodiments or aspects, each data instance of the evaluation dataset may include at least one feature value and a ground truth value. In some non-limiting embodiments or aspects, the one or more instructions that cause the at least one processor to augment the evaluation dataset cause the at least one processor to replace the ground truth value for each data instance of the evaluation dataset with the confidence score for each data instance in the evaluation dataset to provide the augmented evaluation dataset.

In some non-limiting embodiments or aspects, the one or more instructions further cause the at least one processor to receive an input, determine a confidence score for the input, and select a machine learning production model of a plurality of machine learning production models based on the confidence score for the input.

Further non-limiting embodiments or aspects will be set forth in the following numbered clauses:

Clause 1: A system comprising: at least one processor programmed or configured to: train a base machine learning model using a training dataset to generate a trained machine learning model, wherein the base machine learning model is configured to provide a confidence score, wherein the confidence score is a score indicating how sure it is that a machine learning production model will provide a correct prediction of an input at inference; evaluate the trained machine learning model using an evaluation dataset, wherein when evaluating the trained machine learning model using the evaluation dataset, the at least one processor is programmed or configured to: generate a confidence score for each data instance of the evaluation dataset with the trained machine learning model; augment the evaluation dataset based on the confidence score for each data instance of the evaluation dataset to generate an augmented evaluation dataset; and retrain the trained machine learning model using the augmented evaluation dataset to generate a final machine learning model.

Clause 2: The system of clause 1, wherein each data instance of the evaluation dataset comprises at least one feature value and a ground truth value, wherein, when generating the confidence score for each data instance of the evaluation dataset with the trained machine learning model, the at least one processor is programmed or configured to: determine a score of the trained machine learning model for each data instance of the evaluation dataset; and calculate the confidence score for each data instance of the evaluation dataset based on the score of the trained machine learning model for each data instance of the evaluation dataset and the ground truth value for each data instance of the evaluation dataset.

Clause 3: The system of clause 1 or 2, wherein, when calculating the confidence score for each data instance of the evaluation dataset, the at least one processor is programmed or configured to: calculate an absolute value of a difference of the ground truth value and the score of the trained machine learning model; and subtract the absolute value of a difference of the ground truth value and the score of the trained machine learning model from 1 to provide the confidence score.

Clause 4: The system of any of clauses 1-3, wherein each data instance of the evaluation dataset comprises at least one feature value and a ground truth value and wherein, when augmenting the evaluation dataset, the at least one processor is programmed or configured to: replace the ground truth value for each data instance of the evaluation dataset with the confidence score for each data instance in the evaluation dataset to provide the augmented evaluation dataset.

Clause 5: The system of any of clauses 1-4, wherein the at least one processor is further programmed or configured to: receive an input; determine a confidence score for the input; and select a machine learning production model of a plurality of machine learning production models based on the confidence score for the input.

Clause 6: The system of any of clauses 1-5, wherein, when selecting the machine learning production model of the plurality of machine learning production models, the at least one processor is programmed or configured to: compare the confidence score of the input to a plurality of threshold values; determine whether the confidence score of the input satisfies one or more of the plurality of threshold values; and select the machine learning production model of the plurality of machine learning production models based on determining that the confidence score satisfies one or more of the plurality of threshold values.

Clause 7: The system of any of clauses 1-6, wherein, when selecting the machine learning production model of the plurality of machine learning production models, the at least one processor is programmed or configured to: perform a distribution analysis based on the confidence score of the input; and select the machine learning production model of the plurality of machine learning production models based on the distribution analysis.

Clause 8: The system of any of clauses 1-7, wherein the plurality of machine learning production models comprises a first machine learning production model associated with a high confidence score, a second machine learning production model associated with a medium confidence score, and a third machine learning production model associated with a low confidence score, and wherein, when selecting the machine learning production model of the plurality of machine learning production models, the at least one processor is programmed or configured to: determine whether the confidence score of the input corresponds to the high confidence score, the medium confidence score, or the low confidence score; and select the first machine learning production model associated with the high confidence score, the second machine learning production model associated with the medium confidence score, or the third machine learning production model associated with the low confidence score based on determining whether the confidence score of the input corresponds to the high confidence score, the medium confidence score, or the low confidence score.

Clause 9: A computer-implemented method comprising: training, with at least one processor, a base machine learning model using a training dataset to generate a trained machine learning model, wherein the base machine learning model is configured to provide a confidence score, wherein the confidence score is a score indicating how sure it is that a machine learning production model will provide a correct prediction of an input at inference; evaluating, with the at least one processor, the trained machine learning model using an evaluation dataset, wherein evaluating the trained machine learning model using the evaluation dataset comprises: generating a confidence score for each data instance of the evaluation dataset with the trained machine learning model; augmenting, with the at least one processor, the evaluation dataset based on the confidence score for each data instance of the evaluation dataset to generate an augmented evaluation dataset; and retraining, with the at least one processor, the trained machine learning model using the augmented evaluation dataset to generate a final machine learning model.

Clause 10: The computer-implemented method of clause 9, wherein each data instance of the evaluation dataset comprises at least one feature value and a ground truth value, wherein generating the confidence score for each data instance of the evaluation dataset with the trained machine learning model comprises: determining a score of the trained machine learning model for each data instance of the evaluation dataset; and calculating the confidence score for each data instance of the evaluation dataset based on the score of the trained machine learning model for each data instance of the evaluation dataset and the ground truth value for each data instance of the evaluation dataset.

Clause 11: The computer-implemented method of clause 9 or 10, wherein calculating the confidence score for each data instance of the evaluation dataset comprises: calculating an absolute value of a difference of the ground truth value and the score of the trained machine learning model; and subtracting the absolute value of a difference of the ground truth value and the score of the trained machine learning model from 1 to provide the confidence score.

Clause 12: The computer-implemented method of any of clauses 9-11, wherein each data instance of the evaluation dataset comprises at least one feature value and a ground truth value and wherein augmenting the evaluation dataset comprises: replacing the ground truth value for each data instance of the evaluation dataset with the confidence score for each data instance in the evaluation dataset to provide the augmented evaluation dataset.

Clause 13: The computer-implemented method of any of clauses 9-12, further comprising: receiving, with the at least one processor, an input; determining, with the at least one processor, a confidence score for the input; and selecting, with the at least one processor, a machine learning production model of a plurality of machine learning production models based on the confidence score for the input.

Clause 14: The computer-implemented method of any of clauses 9-13, wherein selecting the machine learning production model of the plurality of machine learning production models comprises: comparing the confidence score of the input to a plurality of threshold values; determining whether the confidence score of the input satisfies one or more of the plurality of threshold values; and selecting the machine learning production model of the plurality of machine learning production models based on determining that the confidence score satisfies one or more of the plurality of threshold values.

Clause 15: The computer-implemented method of any of clauses 9-14, wherein selecting the machine learning production model of the plurality of machine learning production models comprises: performing a distribution analysis based on the confidence score of the input; and selecting the machine learning production model of the plurality of machine learning production models based on the distribution analysis.

Clause 16: A computer program product comprising at least one non-transitory computer readable medium including one or more instructions that, when executed by at least one processor, cause the at least one processor to: train a base machine learning model using a training dataset to generate a trained machine learning model, wherein the base machine learning model is configured to provide a confidence score, wherein the confidence score is a score indicating how sure it is that a machine learning production model will provide a correct prediction of an input at inference; evaluate the trained machine learning model using an evaluation dataset, wherein the one or more instructions that cause the at least one processor to evaluate the trained machine learning model using the evaluation dataset cause the at least one processor to: generate a confidence score for each data instance of the evaluation dataset with the trained machine learning model; augment the evaluation dataset based on the confidence score for each data instance of the evaluation dataset to generate an augmented evaluation dataset; and retrain the trained machine learning model using the augmented evaluation dataset to generate a final machine learning model.

Clause 17: The computer program product of clause 16, wherein each data instance of the evaluation dataset comprises at least one feature value and a ground truth value, wherein the one or more instructions that cause the at least one processor to generate the confidence score for each data instance of the evaluation dataset with the trained machine learning model cause the at least one processor to: determine a score of the trained machine learning model for each data instance of the evaluation dataset; and calculate the confidence score for each data instance of the evaluation dataset based on the score of the trained machine learning model for each data instance of the evaluation dataset and the ground truth value for each data instance of the evaluation dataset.

Clause 18: The computer program product of clause 16 or 17, wherein the one or more instructions that cause the at least one processor to calculate the confidence score for each data instance of the evaluation dataset cause the at least one processor to: calculate an absolute value of a difference of the ground truth value and the score of the trained machine learning model; and subtract the absolute value of a difference of the ground truth value and the score of the trained machine learning model from 1 to provide the confidence score.

Clause 19: The computer program product of any of clauses 16-18, wherein each data instance of the evaluation dataset comprises at least one feature value and a ground truth value and wherein the one or more instructions that cause the at least one processor to augment the evaluation dataset cause the at least one processor to: replace the ground truth value for each data instance of the evaluation dataset with the confidence score for each data instance in the evaluation dataset to provide the augmented evaluation dataset.

Clause 20: The computer program product of any of clauses 16-19, wherein the one or more instructions further cause the at least one processor to: receive an input; determine a confidence score for the input; and select a machine learning production model of a plurality of machine learning production models based on the confidence score for the input.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the present disclosure are explained in greater detail below with reference to the exemplary embodiments that are illustrated in the accompanying schematic figures, in which:

FIG. 1 is a diagram of a non-limiting embodiment or aspect of an environment in which systems, devices, products, apparatus, and/or methods, described herein, may be implemented according to the principles of the present disclosure;

FIG. 2 is a diagram of a non-limiting embodiment or aspect of components of one or more devices of FIG. 1;

FIG. 3 is a flowchart of a non-limiting embodiment or aspect of a process for segmenting large scale datasets according to machine learning models based on transfer learning;

FIGS. 4A-4D are diagrams of non-limiting embodiments of an implementation of a process for segmenting large scale datasets according to machine learning models based on transfer learning; and

FIG. 5 is a diagram of a non-limiting embodiment of an implementation of a transfer machine learning system at inference.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like). It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments or aspects, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions, such as credit payment transactions and/or debit payment transactions. For example, an issuer institution may provide an account identifier, such as a primary account number (PAN), to a customer that uniquely identifies one or more accounts associated with that customer. In some non-limiting embodiments or aspects, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments or aspects, may be operated by or on behalf of a transaction service provider.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments or aspects, an acquirer may be a financial institution, such as a bank.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “client” and “client device” may refer to one or more computing devices, such as processors, storage devices, and/or similar computer components, that access a service made available by a server. In some non-limiting embodiments, a client device may include a computing device configured to communicate with one or more networks and/or facilitate transactions such as, but not limited to, one or more desktop computers, one or more portable computers (e.g., tablet computers), one or more mobile devices (e.g., cellular phones, smartphones, personal digital assistant, wearable devices, such as watches, glasses, lenses, and/or clothing, and/or the like), and/or other like devices. Moreover, the term “client” may also refer to an entity that owns, utilizes, and/or operates a client device for facilitating transactions with another entity.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments or aspects of the present disclosure are directed to systems, methods, and computer program products for segmenting large scale datasets according to machine learning models based on transfer learning. In some non-limiting embodiments or aspects, a transfer machine learning system may include at least one processor programmed or configured to train a base machine learning model using a training dataset to generate a trained machine learning model, where the base machine learning model is configured to provide a confidence score indicating how sure it is that a machine learning production model may provide a correct prediction of an input at inference (e.g., how confident, a measure of confidence, whether a machine learning production model will provide a correct prediction, etc.), evaluate the trained machine learning model using an evaluation dataset, augment the evaluation dataset based on the confidence score for each data instance of the evaluation dataset to generate an augmented evaluation dataset, and retrain the trained machine learning model using the augmented evaluation dataset to generate a final machine learning model. In some non-limiting embodiments or aspects, when evaluating the trained machine learning model using the evaluation dataset, the at least one processor is programmed or configured to: generate a confidence score for each data instance of the evaluation dataset with the trained machine learning model. In some non-limiting embodiments, the confidence score may indicate the likelihood that (e.g., a level of certainty by which, how sure a machine learning model is that, and/or the like) a machine learning production model will provide a correct prediction of an input at inference.

In some non-limiting embodiments or aspects, each data instance of the evaluation dataset includes at least one feature value and a ground truth value. In some non-limiting embodiments or aspects, when generating the confidence score for each data instance of the evaluation dataset with the trained machine learning model, the at least one processor is programmed or configured to determine a score of the trained machine learning model for each data instance of the evaluation dataset and calculate the confidence score for each data instance of the evaluation dataset based on the score of the trained machine learning model for each data instance of the evaluation dataset and the ground truth value for each data instance of the evaluation dataset. In some non-limiting embodiments or aspects, when calculating the confidence score for each data instance of the evaluation dataset, the at least one processor is programmed or configured to calculate an absolute value of a difference of the ground truth value and the score of the trained machine learning model and subtract the absolute value of a difference of the ground truth value and the score of the trained machine learning model from 1 to provide the confidence score. In some non-limiting embodiments or aspects, when augmenting the evaluation dataset, the at least one processor is programmed or configured to replace the ground truth value for each data instance of the evaluation dataset with the confidence score for each data instance in the evaluation dataset to provide the augmented evaluation dataset.

In some non-limiting embodiments or aspects, the at least one processor is further programmed or configured to receive an input, determine a confidence score for the input and select a machine learning production model of a plurality of machine learning production models based on the confidence score for the input. In some non-limiting embodiments or aspects, when selecting the machine learning production model of the plurality of machine learning production models, the at least one processor is programmed or configured to compare the confidence score of the input to a plurality of threshold values, determine whether the confidence score of the input satisfies one or more of the plurality of threshold values, and select the machine learning production model of the plurality of machine learning production models based on determining that the confidence score satisfies one or more of the plurality of threshold values.

In some non-limiting embodiments or aspects, when selecting the machine learning production model of the plurality of machine learning production models, the at least one processor is programmed or configured to perform a distribution analysis based on the confidence score of the input and select the machine learning production model of the plurality of machine learning production models based on the distribution analysis. In some non-limiting embodiments or aspects, the plurality of machine learning production models includes a first machine learning production model associated with a high confidence score, a second machine learning production model associated with a medium confidence score, and a third machine learning production model associated with a low confidence score, and when selecting the machine learning production model of the plurality of machine learning production models, the at least one processor is programmed or configured to: determine whether the confidence score of the input corresponds to the high confidence score, the medium confidence score, or the low confidence score and select the first machine learning production model associated with the high confidence score, the second machine learning production model associated with the medium confidence score, or the third machine learning production model associated with the low confidence score based on determining whether the confidence score of the input corresponds to the high confidence score, the medium confidence score, or the low confidence score.

In this way, the transfer machine learning system may allow for reducing resources that are used in segmenting a large scale dataset, for example, by eliminating the need for outside subject matter expertise. In addition, the transfer machine learning system may reduce the opportunity for providing a biased result based on segmenting the dataset. Furthermore, the transfer machine learning system may allow for adaption to dynamic and evolving patterns of the dataset.

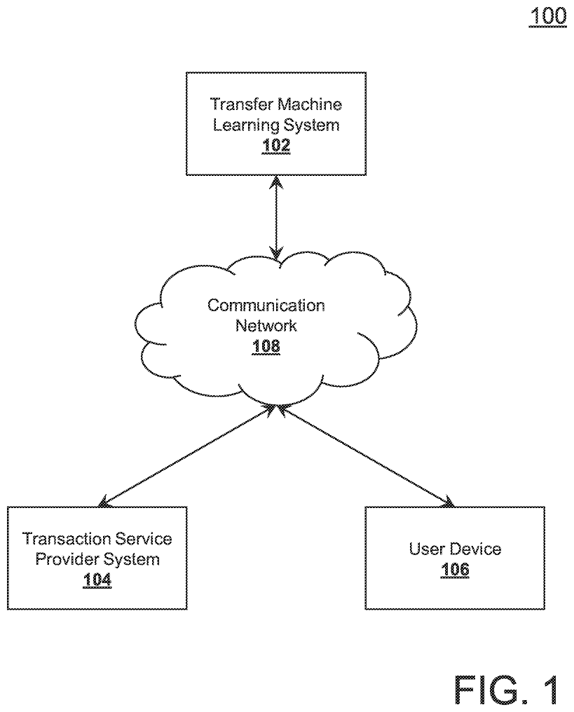

Referring now to FIG. 1, FIG. 1 is a diagram of an example environment 100 in which devices, systems, and/or methods, described herein, may be implemented. As shown in FIG. 1, environment 100 may include transfer machine learning system 102, transaction service provider system 104, user device 106, and communication network 108. Transfer machine learning system 102, transaction service provider system 104, and/or user device 106 may interconnect (e.g., establish a connection to communicate) via wired connections, wireless connections, or a combination of wired and wireless connections.

Transfer machine learning system 102 may include one or more devices configured to communicate with transaction service provider system 104 and/or user device 106 via communication network 108. For example, transfer machine learning system 102 may include a server, a group of servers, and/or other like devices. In some non-limiting embodiments or aspects, transfer machine learning system 102 may be associated with a transaction service provider system, as described herein. Additionally or alternatively, transfer machine learning system 102 may generate (e.g., train, test, validate, retrain, and/or the like), store, and/or implement (e.g., operate, provide inputs to and/or outputs from, and/or the like) one or more machine learning models. In some non-limiting embodiments or aspects, transfer machine learning system 102 may be in communication with a data storage device, which may be local or remote to transfer machine learning system 102. In some non-limiting embodiments or aspects, transfer machine learning system 102 may be capable of receiving information from, storing information in, transmitting information to, and/or searching information stored in the data storage device.

Transaction service provider system 104 may include one or more devices configured to communicate with transfer machine learning system 102 and/or user device 106 via communication network 108. For example, transaction service provider system 104 may include a computing device, such as a server, a group of servers, and/or other like devices. In some non-limiting embodiments or aspects, transaction service provider system 104 may be associated with a transaction service provider system as discussed herein. In some non-limiting embodiments or aspects, transfer machine learning system 102 may be a component of transaction service provider system 104.

User device 106 may include a computing device configured to communicate with transfer machine learning system 102 and/or transaction service provider system 104 via communication network 108. For example, user device 106 may include a computing device, such as a desktop computer, a portable computer (e.g., tablet computer, a laptop computer, and/or the like), a mobile device (e.g., a cellular phone, a smartphone, a personal digital assistant, a wearable device, and/or the like), and/or other like devices. In some non-limiting embodiments or aspects, user device 106 may be associated with a user (e.g., an individual and/or user operating user device 106).

Communication network 108 may include one or more wired and/or wireless networks. For example, communication network 108 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN) and/or the like), a private network, an ad hoc network, an intranet, the Internet, a fiber optic-based network, a cloud computing network, and/or the like, and/or a combination of some or all of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

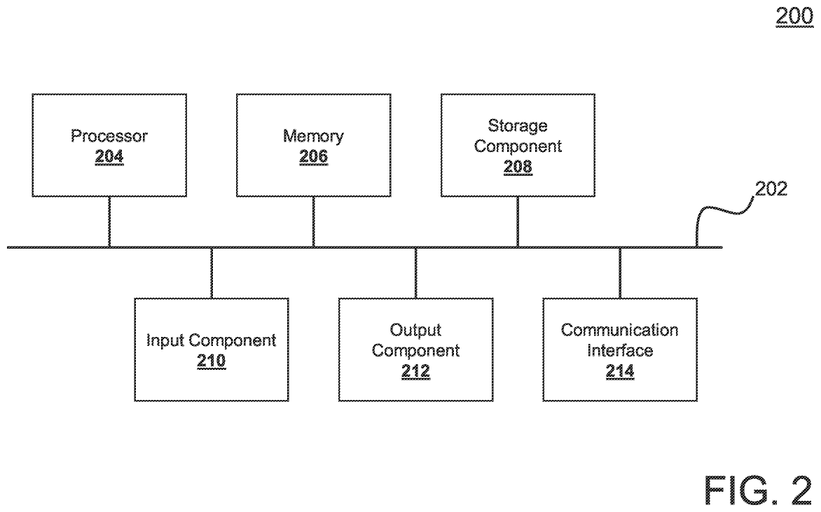

Referring now to FIG. 2, FIG. 2 is a diagram of example components of a device 200. Device 200 may correspond to transfer machine learning system 102 (e.g., one or more devices of transfer machine learning system 102), transaction service provider system 104 (e.g., one or more devices of transaction service provider system 104), and/or user device 106. In some non-limiting embodiments or aspects, transfer machine learning system 102, transaction service provider system 104, and/or user device 106 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

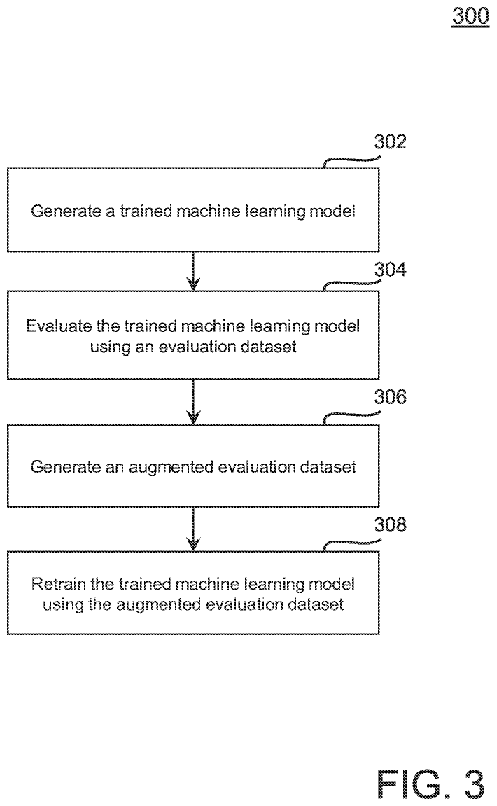

Referring now to FIG. 3, FIG. 3 is a flowchart of a non-limiting embodiment or aspect of a process 300 for segmenting large scale datasets according to machine learning models based on transfer learning. In some non-limiting embodiments or aspects, one or more of the steps of process 300 may be performed (e.g., completely, partially, etc.) by transfer machine learning system 102 (e.g., one or more devices of transfer machine learning system 102). In some non-limiting embodiments or aspects, one or more of the steps of process 300 may be performed (e.g., completely, partially, etc.) by another device or a group of devices separate from or including transfer machine learning system 102 (e.g., one or more devices of transfer machine learning system 102), transaction service provider system 104 (e.g., one or more devices of transaction service provider system 104), and/or user device 106.

In some non-limiting embodiments or aspects, one or more of the steps of a process (e.g., process 300) may be performed during a training phase. The training phase may include an environment (e.g., a training environment) and/or a time period (e.g., training phase, model building phase, and/or the like) where a machine learning model (e.g., a machine learning algorithm) may be trained. Training may refer to inputting training input data (e.g., a training dataset) into one or more machine learning algorithms and/or models (e.g., one or more machine learning algorithms and/or models of transfer machine learning system 102), applying labels to the training input data for training, and/or mapping the training input data to one or more target values (e.g., ground truth values, the values that a trained machine learning model may predict, and/or the like), for the purpose of generating a trained machine learning model. In some non-limiting embodiments or aspects, training may be performed during a training phase before a testing phase and before a runtime (e.g., inference, production) phase. During a time period associated with the training phase, the machine learning model may process the input data to find patterns in the input data that map the input data (e.g., features and/or attributes of the input data) to the one or more target values to generate the trained machine learning model.

In some non-limiting embodiments or aspects, one or more of the steps of a process (e.g., process 300) may be performed during a testing phase. The testing phase may include an environment (e.g., a testing environment) and/or a time period (e.g., a testing phase, model evaluation phase, and/or the like) where a machine learning model (e.g., a trained machine learning model, a trained inference model, and/or the like) may be tested (e.g., evaluated, validated, and/or the like). Testing (e.g., evaluating) may refer to inputting testing input data (e.g., a testing dataset, an evaluation dataset) into one or more trained machine learning models (e.g., one or more trained machine learning models of transfer machine learning system 102) and/or determining a metric associated with an accuracy of the trained machine learning model based on the testing input data. In some non-limiting embodiments or aspects, the testing input data may include a sample of data including target values generated during the training phase based on the training input data (e.g., output from the training phase, a sample of data that has labels applied with the target values during training). In some non-limiting embodiments or aspects, determining a metric associated with an accuracy of the trained machine learning model based on the testing input data may include comparing the testing input data with testing output data (e.g., test inferences, test predictions) from the trained machine learning model. For example, a metric associated with an accuracy may be determined by comparing labels applied to the testing output data with the target values of the sample of data in the testing input data. In some non-limiting embodiments or aspects, testing may be performed during a testing phase after a training phase and before deployment of the machine learning model and/or a runtime (e.g., inference, production) phase. During a time period associated with the testing phase, the machine learning model (e.g., the trained machine learning model) may process the testing input data to determine a metric associated with the accuracy of the trained machine learning model to test and/or evaluate the trained machine learning model.

In some non-limiting embodiments or aspects, one or more of the steps of a process (e.g., process 300) may be performed during a runtime phase. The runtime phase may include an environment (e.g., a runtime environment) and/or a time period (e.g., a runtime phase) where a trained and/or tested machine learning model (e.g., a runtime machine learning model, a machine learning production model, a production inference model, and/or the like) may be used to generate inferences (e.g., predictions, real-time inferences, and/or the like). Runtime (e.g., inference, production) may refer to inputting runtime data (e.g., a runtime dataset, real-world data, observations, inference data, and/or the like) into one or more trained and/or tested machine learning models (e.g., one or more trained machine learning models of transfer machine learning system 102) and/or generating an inference (e.g., generating an inference using transfer machine learning system 102). In some non-limiting embodiments or aspects, the runtime input data may include a sample of data that is received by the trained machine learning model in real-time with respect to the runtime input data being generated. For example, runtime input data may be generated by a data source (e.g., a customer performing a transaction) and may be subsequently received by the trained machine learning model in real-time. In some non-limiting embodiments or aspects, runtime may be performed during a runtime phase after a training phase and after deployment of the machine learning model. During a time period associated with the runtime phase, the machine learning model (e.g., the trained machine learning model, the machine learning production model) may process the runtime input data to generate inferences (e.g., real-time inferences).

In some non-limiting embodiments or aspects, real-time may refer to an instant in time with respect to the occurrence of an event (e.g., real-time with respect to a transaction, real-time with respect to data being generated, real-time with respect to the reading or writing of data, etc.) where a response may occur within a specified time, generally a relatively short time. For example, real-time may refer to an instant in time where an inference is generated by a machine learning model (e.g., a machine learning model of transfer machine learning system 102) concurrent with or shortly after (e.g., within milliseconds) the generation of the input data and/or the receipt of the input data by the machine learning model. As a further example, a real-time output may be generated with respect to a real-time input concurrent with or within milliseconds of receiving the real-time input (e.g., a transaction may be approved immediately concurrent with or shortly after the transaction is initiated by a customer).

As shown in FIG. 3, at step 302, process 300 may include generating a trained machine learning model. For example, transfer machine learning system 102 may generate the trained machine learning model. In some non-limiting embodiments or aspects, transfer machine learning system 102 may train a base machine learning model using a training dataset to generate a trained machine learning model. In some non-limiting embodiments or aspects, the base machine learning model may be configured to provide a confidence score and the confidence score may include a score indicating how sure it is that a machine learning production model will provide a correct prediction of an input at inference (e.g., how confident, a measure of confidence, whether a machine learning production model will provide a correct prediction, etc.). In some non-limiting embodiments, the confidence score may indicate that the machine learning production model will or will not provide a correct prediction of an input at inference. In some non-limiting embodiments, the confidence score may indicate the likelihood, such as a level of certainty by which (e.g., how sure a machine learning model is that) a machine learning production model will provide a correct prediction of an input at inference. For example, the confidence score may indicate how confident a prediction from a machine learning production model is when the confidence score is applied to an input at inference.

In some non-limiting embodiments or aspects, the trained machine learning model may include a confidence engine and/or a confidence machine learning model. The trained machine learning model may include a deep learning model that is trained based on transfer learning.

In some non-limiting embodiments or aspects, transfer machine learning system 102 may process an input using a machine learning (ML) technique. For example, transfer machine learning system 102 may process one or more inputs (e.g., one or more transactions, one or more features of a transaction, transaction data, etc.) using an ML technique. In some non-limiting embodiments, transfer machine learning system 102 may process an input using a machine learning model (e.g., a base machine learning model, a trained machine learning model, a final machine learning model, a machine learning production model, etc.). For example, transfer machine learning system 102 may provide the input (e.g., data associated with a transaction, such as a transaction time, a transaction amount, etc.) as an input to the trained machine learning model (e.g., a confidence engine machine learning model) and receive an output from the trained machine learning model based on the input. The output may include a score (e.g., a confidence score) indicating the likelihood that (e.g., a level of certainty by which, how sure a machine learning model is that, and/or the like) a machine learning production model will provide a correct prediction of an input at inference. For example, the output may include a confidence score indicating how confident a prediction from a machine learning production model is when the confidence score is applied on an input inference.

In some non-limiting embodiments, when processing the input using the machine learning model, transfer machine learning system 102 may classify the input using the machine learning model and/or score (e.g., rate, rank, provide a confidence score, etc.) the input using the machine learning model. For example, the final machine learning model may generate a confidence score based on processing the input. The final machine learning model may classify the confidence score as indicating a high confidence (e.g., a highest confidence level of a plurality of confidence levels), a medium confidence (e.g., one or more confidence levels below and/or less than a highest confidence level and above and/or greater than a lowest confidence level), or a low confidence (e.g., a lowest confidence level of a plurality of confidence levels) based on a value of the confidence score.

In some non-limiting embodiments, when classifying the input, transfer machine learning system 102 may determine a classification associated with a category of inputs (e.g., a category of transactions, such as fraudulent transactions, valid transactions, etc.) to which the input is to be assigned (e.g., labeled). In some non-limiting embodiments, when scoring the input, transfer machine learning system 102 may determine a metric (e.g., a rating, a ranking, a score, such as a confidence score, etc.) regarding a predicted accuracy of a classification associated with a category of inputs to which the input is to be assigned (e.g., labeled) provided by the machine learning model (e.g., a machine learning production model of the plurality of machine learning production models).

In some non-limiting embodiments, transfer machine learning system 102 may generate the machine learning model (e.g., the trained machine learning model, the final machine learning model, a confidence engine machine learning model, and/or the like). For example, transfer machine learning system 102 may generate the final machine learning model based on data associated with a plurality of confidence scores (e.g., data associated with inputs, data associated with one or more confidence scores generated based on inputs, and/or the like).

In some non-limiting embodiments, the machine learning model (e.g., the final machine learning model) may be designed to receive, as an input, data associated with one or more transactions, and provide, as an output, a confidence score as to how confident a prediction from a machine learning production model may be when the machine learning production model receives the input at inference. For example, the final machine learning model may receive the input and may provide the output that includes a confidence score indicating a high confidence that a machine learning production model may generate a correct prediction when the machine learning production model receives the input. In another example, the final machine learning model may receive the input and may provide the output that includes a confidence score indicating a low confidence that a machine learning production model may generate a correct prediction when the machine learning production model receives the input.

In some non-limiting embodiments, the machine learning model may be designed to receive, as an input, one or more features associated with a transaction, which may be identified as predictor variables and associated with data included in a transaction (e.g., a transaction amount included in a transaction), and provide, as an output, a prediction (e.g., a probability, a binary output, a yes-no output, a score, a prediction score, and/or the like) that the transaction should be assigned to a category of a plurality of categories associated with levels of confidence scores and/or a category of transactions (e.g., fraudulent transactions, valid transactions, etc.).

In some non-limiting embodiments, transfer machine learning system 102 may receive data from user device 106 and/or other devices (e.g., other user devices 106). Transfer machine learning system 102 may analyze the data to generate the trained learning model and/or the final machine learning model based on receiving the data. In some non-limiting embodiments, transfer machine learning system 102 may generate the trained machine learning model and/or the final machine learning model by generating a rule for the trained machine learning model and/or the final machine learning model based on the data (e.g., historical data, transaction data). In some non-limiting embodiments, historical data may include data associated with one or more transactions that have been assigned (e.g., previously assigned) to a category associated with transactions.

In some non-limiting embodiments, transfer machine learning system 102 may process the data to obtain training data for the machine learning model. For example, transfer machine learning system 102 may process the data to change the data into a format that may be analyzed (e.g., by transfer machine learning system 102) to generate a final machine learning model. The data that is changed may be referred to as training data (e.g., a training dataset, an evaluation dataset, an augmented evaluation dataset, etc.). In some non-limiting embodiments, transfer machine learning system 102 may process the data to obtain the training data based on receiving the data. Additionally or alternatively, transfer machine learning system 102 may process the data to obtain the training data based on transfer machine learning system 102 receiving an indication that transfer machine learning system 102 is to process the data from a user (e.g., a user of user device 106) of transfer machine learning system 102, such as when transfer machine learning system 102 receives an indication to create a machine learning model.

In some non-limiting embodiments, transfer machine learning system 102 may analyze the training data to generate the machine learning model. For example, transfer machine learning system 102 may use machine learning techniques to analyze the training data to generate the final machine learning model. In some non-limiting embodiments, generating the final machine learning model (e.g., based on training data obtained from historical data) may be referred to as training the final machine learning model. The machine learning techniques may include, for example, supervised and/or unsupervised techniques, such as decision trees, logistic regressions, artificial neural networks, Bayesian statistics, learning automata, Hidden Markov Modeling, linear classifiers, quadratic classifiers, association rule learning, or the like. In some non-limiting embodiments, the machine learning techniques may include supervised techniques, such as artificial neural networks (e.g., convolution neural networks) and/or the like. In some non-limiting embodiments, the machine learning model may include a model that is specific to a particular category of government affairs, a particular set of categories of government affairs, a particular group of users, a particular geographic location (e.g., a city, a state, a country, etc.) related to transactions, and/or the like. Additionally or alternatively, the machine learning model may be specific to a particular organization (e.g., a particular business entity, a particular government agency, etc.). In some non-limiting embodiments, transfer machine learning system 102 may generate one or more machine learning models for one or more organizations, one or more groups associated with a particular area (e.g., category) of transactions, and/or a particular group of users.

Additionally or alternatively, when analyzing the training data, transfer machine learning system 102 may identify one or more variables (e.g., one or more independent variables) as predictor variables that may be used to make a prediction (e.g., when analyzing the training data). In some non-limiting embodiments, values of the predictor variables may be inputs to the machine learning model (e.g., the final machine learning model). For example, transfer machine learning system 102 may identify a subset (e.g., a proper subset) of the variables as predictor variables that may be used to accurately predict a group to which a transaction may be assigned. In some non-limiting embodiments, the predictor variables may include one or more of the variables, as discussed above, which have a significant impact (e.g., an impact satisfying a threshold) on a probability that a transaction is to be assigned to a category of a plurality of categories of transactions and/or confidence scores as determined by transfer machine learning system 102.

In some non-limiting embodiments, transfer machine learning system 102 may validate the machine learning model. For example, transfer machine learning system 102 may validate the trained machine learning model after transfer machine learning system 102 generates the trained machine learning model. In some non-limiting embodiments, transfer machine learning system 102 may validate the machine learning model based on a portion of the training data to be used for validation. For example, transfer machine learning system 102 may partition the training data into a first portion and a second portion, where the first portion may be used to generate the machine learning model, as described above. In this example, the second portion of the training data (e.g., the validation data, the evaluation data, the evaluation dataset, etc.) may be used to validate the machine learning model.

In some non-limiting embodiments, transfer machine learning system 102 may validate the machine learning model by providing validation data associated with a transaction (e.g., data associated with one or more transactions associated with a category of transactions, data associated with one or more transactions assigned to a category of transactions, data associated with one or more transactions assigned to one or more categories of transactions of a plurality of categories of transactions, and/or the like) as input to the machine learning model, and determining, based on an output of the machine learning model (e.g., a machine learning production model of the plurality of machine learning production models), whether the machine learning model correctly, or incorrectly, predicted that a transaction is to be assigned to a category of transactions. In some non-limiting embodiments, transfer machine learning system 102 may validate the machine learning model based on a validation threshold. For example, transfer machine learning system 102 may be configured to validate each of the machine learning production models of the plurality of machine learning production models when a threshold value (e.g., the validation threshold) of transactions are correctly predicted by the trained machine learning model (e.g., when the machine learning model correctly predicts 50% of the transactions are to be assigned to a category, 70% of the transactions are to be assigned to a category, a threshold number of the transactions are to be assigned to a category, and/or the like).

In some non-limiting embodiments, if transfer machine learning system 102 does not validate the machine learning model (e.g., when a percentage of correctly predicted transactions does not satisfy the validation threshold), then transfer machine learning system 102 may generate additional machine learning models. For example, transfer machine learning system may generate one or more additional machine learning production models if transfer machine learning system 102 does not validate a machine learning production model. In another example, transfer machine learning system 102 may generate a new final machine learning model if transfer machine learning system 102 does not validate the final machine learning model.

In some non-limiting embodiments, once the machine learning model has been validated, transfer machine learning system 102 may further train (e.g., retrain) the machine learning model and/or create new machine learning models (e.g., a final machine learning model, additional machine learning production models, etc.) based on receiving new training data. The new training data may include additional data associated with one or more transactions. In some non-limiting embodiments, the new training data may include data relating to a plurality of confidence scores. For example, transfer machine learning system 102 may use the machine learning model (e.g., the trained machine learning model, the final machine learning model, a machine learning production model of the plurality of machine learning production models, etc.) to predict that a transaction is to be assigned to a category of a level of confidence (e.g., high confidence, medium confidence, low confidence) based on a confidence score assigned to the input (e.g., transaction) and transmit the input to a machine learning production model of a plurality of machine learning production models that is associated with that category of a level of confidence. In such an example, transfer machine learning system 102 may update one or more machine learning production models of the plurality of machine learning production models, the trained machine learning model, and/or the final machine learning model based on this new training data.

In some non-limiting embodiments, transfer machine learning system 102 may store the machine learning model. For example, transfer machine learning system 102 may store the machine learning model in a data structure (e.g., a database, a linked list, a tree, and/or the like). The data structure may be located within transfer machine learning system 102 or external, and possibly remote from, transfer machine learning system 102. In one example, the data structure may be located in communication network 108.

As shown in FIG. 3, at step 304, process 300 includes evaluating the trained machine learning model using an evaluation dataset. For example, transfer machine learning system 102 may evaluate the trained machine learning model using the evaluation dataset. In some non-limiting embodiments or aspects, when evaluating the trained machine learning model using the evaluation dataset, transfer machine learning system 102 may generate a confidence score for each data instance of the evaluation dataset with the trained machine learning model.

In some non-limiting embodiments or aspects, each data instance of the evaluation dataset may include at least one feature value and a ground truth value. In some non-limiting embodiments or aspects, when generating the confidence score for each data instance of the evaluation dataset with the trained machine learning model, transfer machine learning system 102 may determine a score of the trained machine learning model for each data instance of the evaluation dataset and calculate the confidence score for each data instance of the evaluation dataset based on the score of the trained machine learning model for each data instance of the evaluation dataset and the ground truth value for each data instance of the evaluation dataset. In some non-limiting embodiments or aspects, when calculating the confidence score for each data instance of the evaluation dataset, transfer machine learning system 102 may calculate an absolute value of a difference of the ground truth value and the score of the trained machine learning model and subtract the absolute value of a difference of the ground truth value and the score of the trained machine learning model from 1 to provide the confidence score.

As shown in FIG. 3, at step 306, process 300 may include generating an augmented evaluation dataset. For example, transfer machine learning system 102 may generate the augmented evaluation dataset. In some non-limiting embodiments or aspects, transfer machine learning system 102 may augment the evaluation dataset based on the confidence score for each data instance of the evaluation dataset to generate the augmented evaluation dataset. In some non-limiting embodiments or aspects, when augmenting the evaluation dataset, transfer machine learning system 102 may replace the ground truth value for each data instance of the evaluation dataset with the confidence score for each data instance in the evaluation dataset to provide the augmented evaluation dataset.

As shown in FIG. 3, at step 308, process 300 may include retraining the trained machine learning model using the augmented evaluation dataset. For example, transfer machine learning system 102 may retrain the trained machine learning model using the augmented evaluation dataset. In some non-limiting embodiments or aspects, transfer machine learning system 102 may retrain the trained machine learning model and/or create new machine learning models (e.g., a final machine learning model) based on receiving new training data. In some non-limiting embodiments, the new training data may include data relating to a plurality of confidence scores (e.g., the augmented evaluation dataset). In some non-limiting embodiments or aspects, transfer machine learning system 102 may receive an input, determine a confidence score for the input, and select a machine learning production model of a plurality of machine learning production models based on the confidence score for the input. In some non-limiting embodiments or aspects, when selecting the machine learning production model of the plurality of machine learning production models, transfer machine learning system 102 may compare the confidence score of the input to a plurality of threshold values, determine whether the confidence score of the input satisfies one or more of the plurality of threshold values, and select the machine learning production model of the plurality of machine learning production models based on determining that the confidence score satisfies one or more of the plurality of threshold values. In some non-limiting embodiments or aspects, when selecting the machine learning production model of the plurality of machine learning production models, transfer machine learning system 102 may perform a distribution analysis based on the confidence score of the input and select the machine learning production model of the plurality of machine learning production models based on the distribution analysis.

In some non-limiting embodiments or aspects, transfer machine learning system 102 may process the input using a ML technique. For example, transfer machine learning system 102 may process one or more inputs (e.g., one or more transactions, one or more features of a transaction, transaction data, etc.) using an ML technique. In some non-limiting embodiments, transfer machine learning system 102 may process an input using the final machine learning model. For example, transfer machine learning system 102 may provide the input (e.g., data associated with a transaction, such as a transaction time, a transaction amount, etc.) as an input to the final machine learning model (e.g., a confidence engine machine learning model) and receive an output from the final machine learning model based on the input. The output may include a score (e.g., a confidence score) indicating the likelihood that (e.g., a level of certainty by which, how sure a machine learning model is that, and/or the like) a machine learning production model will provide a correct prediction of an input at inference. For example, the output may include a confidence score indicating how confident a prediction from a machine learning production model is when the confidence score is applied on an input inference.

In some non-limiting embodiments, when processing the input using the final machine learning model, transfer machine learning system 102 may classify the input using the final machine learning model and/or score (e.g., rate, rank, provide a confidence score, etc.) the input using the final machine learning model. For example, the final machine learning model may generate a confidence score based on processing the input. The final machine learning model may classify the confidence score as indicating a high confidence (e.g., a highest confidence level of a plurality of confidence levels), a medium confidence (e.g., one or more confidence levels below and/or less than a highest confidence level and above and/or greater than a lowest confidence level), or a low confidence (e.g., a lowest confidence level of a plurality of confidence levels) based on a value of the confidence score.

In some non-limiting embodiments, when classifying the input, transfer machine learning system 102 may determine a classification associated with a category of inputs (e.g., a category of a level of confidence, a category of transactions, such as fraudulent transactions, valid transactions, etc.) to which the input is to be assigned (e.g., labeled). For example, transfer machine learning system 102 may determine a classification associated with a category of a level of confidence (e.g., high confidence, medium confidence, low confidence) based on a confidence score assigned to the input and transmit the input to a machine learning production model of a plurality of machine learning production models that is associated with that category of a level of confidence.

In some non-limiting embodiments or aspects, the plurality of machine learning production models may include a first machine learning production model associated with a high confidence score, a second machine learning production model associated with a medium confidence score, and a third machine learning production model associated with a low confidence score. In some non-limiting embodiments or aspects, when selecting the machine learning production model of the plurality of machine learning production models, transfer machine learning system 102 may determine whether the confidence score of the input corresponds to a high confidence score, a medium confidence score, or a low confidence score and select the first machine learning production model associated with a high confidence score, the second machine learning production model associated with a medium confidence score, or the third machine learning production model associated with a low confidence score based on determining whether the confidence score of the input corresponds to a high confidence score, a medium confidence score, or a low confidence score.

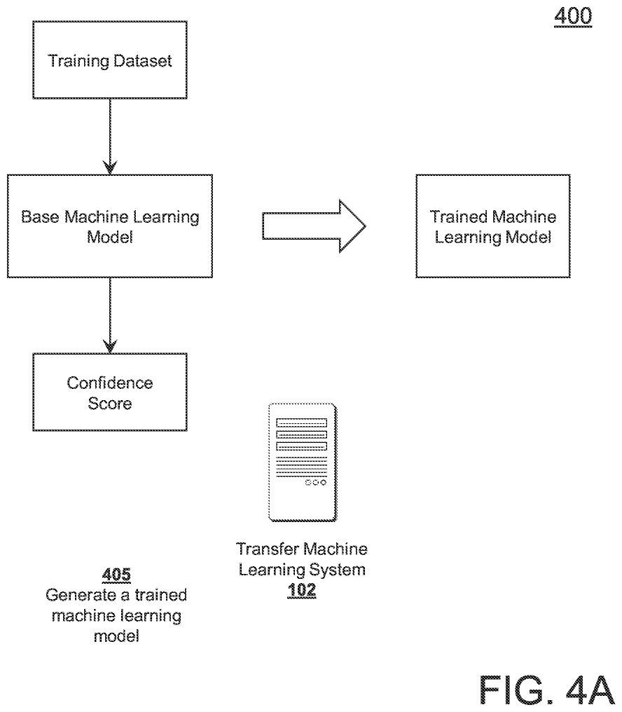

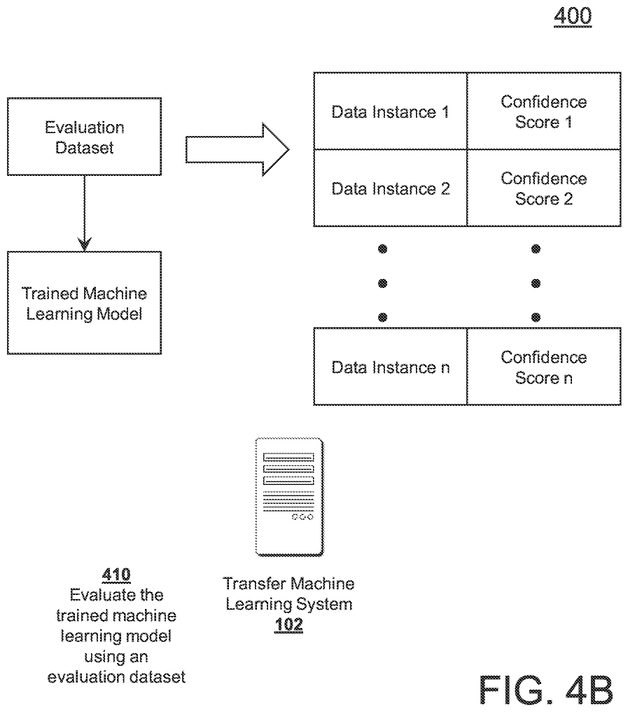

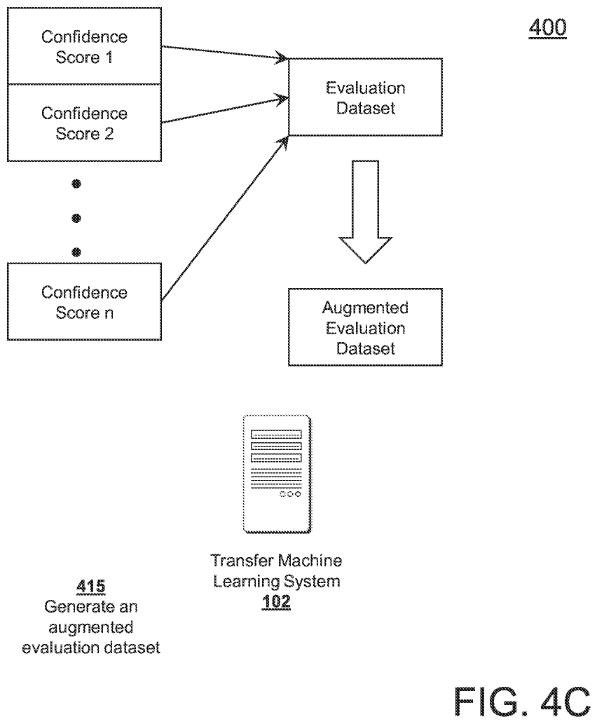

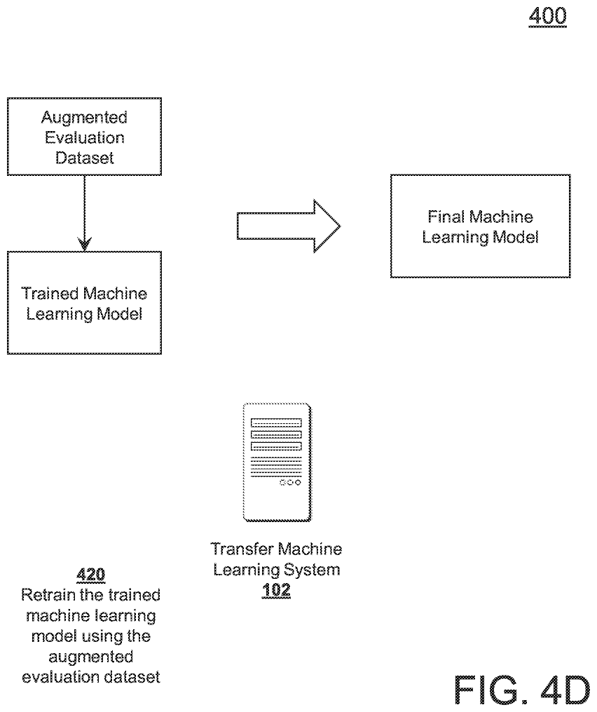

Referring now to FIGS. 4A-4D, FIGS. 4A-4D are diagrams of non-limiting embodiments of an implementation 400 of a process (e.g., process 300) for segmenting large scale datasets according to machine learning models based on transfer learning. As shown in FIGS. 4A-4D, implementation 400 may include transfer machine learning system 102 performing the steps of the process.

As shown by reference number 405 in FIG. 4A, transfer machine learning system 102 may generate a trained machine learning model. For example, transfer machine learning system 102 may train a base machine learning model using a training dataset to generate the trained machine learning model. In some non-limiting embodiments or aspects, the base machine learning model may be configured to provide a confidence score. In some non-limiting embodiments or aspects, the confidence score may be a score indicating how sure it is that a machine learning production model will provide a correct prediction of an input at inference (e.g., how confident, a measure of confidence, whether a machine learning production model will provide a correct prediction, etc.). For example, the confidence score may be a score indicating how confident a prediction from a machine learning production model is when the confidence score is applied to (e.g., when the confidence score is associated with) an input at inference. In some non-limiting embodiments or aspects, the confidence score may be a score indicating a probability that a prediction from a machine learning model may be correct and/or incorrect at inference.

In some non-limiting embodiments or aspects, the training dataset may include training data including at least one feature (e.g., an individual measurable property of the training data, a data point, a feature value, and/or the like). For example, the training dataset may include training data including at least one feature associated with transactions such as transaction times, transaction amounts, PANs, and/or the like. In some non-limiting embodiments or aspects, the training dataset may include training data including target values (e.g., ground truth values).

As shown by reference number 410 in FIG. 4B, transfer machine learning system 102 may evaluate (e.g., test) the trained machine learning model using an evaluation dataset. In some non-limiting embodiments or aspects, when evaluating the trained machine learning model using the evaluation dataset, transfer machine learning system 102 may generate a confidence score for each data instance of the evaluation dataset with the trained machine learning model.

In some non-limiting embodiments or aspects, the evaluation dataset may include evaluation data including at least one feature (e.g., an individual measurable property of the evaluation data, a data point, a feature value, and/or the like). For example, the evaluation dataset may include evaluation data including at least one feature associated with transactions such as transaction times, transaction amounts, PANs, and/or the like. In some non-limiting embodiments or aspects, the evaluation dataset may include evaluation data including target values (e.g., ground truth values).

In some non-limiting embodiments or aspects, each data instance may be associated with one or more segments of data of a plurality of segments of data, each segment of data of the plurality of segments of data representing a sub-population of a population of data (e.g., the training dataset). In some non-limiting embodiments or aspects, each segment of data may include a group of data associated with a property (e.g., a geographic region, a transaction type, and/or the like). In some non-limiting embodiments or aspects, each segment of data may be associated with a level of difficulty (e.g., a high level of difficulty, a medium level of difficulty, and/or a low level of difficulty) indicating a difficulty with which a machine learning production model may provide a correct prediction of an input at inference. In some non-limiting embodiments or aspects, each segment of data may be associated with a machine learning production model of the plurality of machine learning production models.

In some non-limiting embodiments or aspects, each machine learning production model of the plurality of machine learning production models may be associated with a level of difficulty (e.g., a high level of difficulty, a medium level of difficulty, and/or a low level of difficulty) indicating a difficulty with which a machine learning production model may provide a correct prediction of an input at inference. In some non-limiting embodiments or aspects, the machine learning production model that is associated with a higher level of difficulty (e.g., a high level of difficulty, a low confidence, and/or the like) of the plurality of machine learning production models may include a learning rate (e.g., step size) having a value that is less than (e.g., smaller than) a learning rate of the other machine learning production models of the plurality of machine learning production models. For example, as the level of difficulty associated with a machine learning production model increases, the value of the learning rate of the machine learning production model should decrease.

In some non-limiting embodiments or aspects, each machine learning production model of the plurality of machine learning production models may be trained based on each segment of data. For example, a first machine learning production model may be trained based on a first segment of data, a second machine learning production model may be trained based on a second segment of data, a third machine learning production model may be trained based on a third segment of data, and so on. In some non-limiting embodiments or aspects, each machine learning production model of the plurality of machine learning production models may be trained based on one or more segments of data of the plurality of segments of data.

In some non-limiting embodiments or aspects, each data instance of the evaluation dataset may include at least one feature value and a ground truth value. In some non-limiting embodiments or aspects, when generating the confidence score for each data instance of the evaluation dataset with the trained machine learning model, transfer machine learning system 102 may determine a score of the trained machine learning model for each data instance of the evaluation dataset. In some non-limiting embodiments or aspects, when generating the confidence score for each data instance of the evaluation dataset with the trained machine learning model, transfer machine learning system 102 may calculate the confidence score for each data instance of the evaluation dataset based on the score of the trained machine learning model for each data instance of the evaluation dataset and the ground truth value for each data instance of the evaluation dataset.

In some non-limiting embodiments or aspects, when calculating the confidence score for each data instance of the evaluation dataset, transfer machine learning system 102 may calculate an absolute value of a difference of the ground truth value and the score (e.g., a predicted score) of the trained machine learning model and subtract the absolute value of a difference of the ground truth value and the score of the trained machine learning model from 1 to provide the confidence score. In some non-limiting embodiments or aspects, transfer machine learning system 102 may calculate the confidence score for each data instance of the evaluation dataset based on the following equation:

$$Confidence Score = 1 - \vert y - \hat{p} ( x ) \vert ,$$

where y is the ground truth value, x is an input (e.g., an input feature value, a data instance, and/or the like), and \hat{p}(x) is a predicted score (e.g., a predicted score based on the input).

As a first example, transfer machine learning system 102 may generate a first score (e.g., a predicted score) of the trained machine learning model equal to a value of 0.9 based on a first data instance of the evaluation dataset. The first data instance may include a ground truth value of 1. Transfer machine learning system 102 may apply the equation to generate a first confidence score:

$$Confidence Score = 1 - \vert 1 - 0.9 \vert = 0. 9$$

Thus, transfer machine learning system 102 may generate a first confidence score of 0.9 based on the first data instance. In some non-limiting embodiments or aspects, a confidence score of 0.9 may be a value associated with high confidence.

As a second example, transfer machine learning system 102 may generate a second score (e.g., a predicted score) of the trained machine learning model equal to a value of 0.5 based on a second data instance of the evaluation dataset. The second data instance may include a ground truth value of 0. Transfer machine learning system 102 may apply the equation to generate a second confidence score:

$$Confidence Score = 1 - \vert 0 - 0.5 \vert = 0. 5$$

Thus, transfer machine learning system 102 may generate a second confidence score of 0.5 based on the second data instance. In some non-limiting embodiments or aspects, a confidence score of 0.5 may be a value associated with a medium confidence.

As a third example, transfer machine learning system 102 may generate a third score (e.g., a predicted score) of the trained machine learning model equal to a value of 0.7 based on a third data instance of the evaluation dataset. The third data instance may include a ground truth value of 0. Transfer machine learning system 102 may apply the equation to generate a third confidence score:

$$Confidence Score = 1 - \vert 0 - 0.7 \vert = 0. 3$$

Thus, transfer machine learning system 102 may generate a third confidence score of 0.3 based on the third data instance. In some non-limiting embodiments or aspects, a confidence score of 0.3 may be a value associated with a low confidence. Although a particular equation is described with reference to transfer machine learning system 102 calculating a confidence score in non-limiting embodiments or aspects, it should be appreciated that other methods, equations, and/or expressions may be implemented to generate and/or calculate a confidence score.

As shown by reference number 415 in FIG. 4C, transfer machine learning system 102 may generate an augmented evaluation dataset. For example, transfer machine learning system 102 may generate an augmented evaluation dataset by augmenting the evaluation dataset based on the confidence score for each data instance of the evaluation dataset. In some non-limiting embodiments or aspects, when augmenting the evaluation dataset, transfer machine learning system 102 may replace the ground truth value for each data instance of the evaluation dataset with the confidence score for each data instance in the evaluation dataset to provide the augmented evaluation dataset.

In some non-limiting embodiments or aspects, the augmented evaluation dataset may include augmented evaluation data including at least one feature (e.g., an individual measurable property of the evaluation data, a data point, a feature value, and/or the like). For example, the augmented evaluation dataset may include augmented evaluation data including at least one feature associated with transactions such as transaction times, transaction amounts, PANs, and/or the like. In some non-limiting embodiments or aspects, the augmented evaluation dataset may include augmented evaluation data including target values (e.g., ground truth values) representing confidence scores (e.g., confidence scores generated by the trained machine learning model).

As shown by reference number 420 in FIG. 4D, transfer machine learning system 102 may retrain the trained machine learning model using the augmented evaluation dataset. For example, transfer machine learning system 102 may retrain the trained machine learning model to generate a final machine learning model. In some non-limiting embodiments or aspects, the final machine learning model may include a confidence engine and/or a confidence machine learning model. The final machine learning model may include a deep learning model that is trained based on transfer learning.

In some non-limiting embodiments or aspects, transfer machine learning system 102 may receive an input (e.g., transaction data). In some non-limiting embodiments or aspects, transfer machine learning system 102 may determine a confidence score for the input. For example, transfer machine learning system 102 may determine the confidence score for the input based on the final machine learning model. In some non-limiting embodiments or aspects, transfer machine learning system 102 may select a machine learning production model of a plurality of machine learning production models based on the confidence score for the input (e.g., the confidence score determined and/or generated by the final machine learning model based on the input). In some non-limiting embodiments or aspects, transfer machine learning system 102 may route the input to the machine learning production model (e.g., the selected machine learning production model) for processing. In some non-limiting embodiments or aspects, the machine learning production model may process the input by generating a predicted score based on the input. In this way, each machine learning production model may process the input the machine learning production model has been trained on based on the confidence score. Thus, transfer machine learning system 102 may provide an improved runtime performance by routing inputs to the proper machine learning production model which is best capable to handle processing the input at inference.

In some non-limiting embodiments or aspects, when selecting the machine learning production model of the plurality of machine learning production models, transfer machine learning system 102 may compare the confidence score of the input to a plurality of threshold values. Transfer machine learning system 102 may determine whether the confidence score of the input satisfies one or more of the plurality of threshold values. Transfer machine learning system 102 may select the machine learning production model of the plurality of machine learning production models based on determining that the confidence score satisfies one or more of the plurality of threshold values. In some non-limiting embodiments or aspects, when selecting the machine learning production model of the plurality of machine learning production models, transfer machine learning system 102 may perform a distribution analysis based on the confidence score of the input and transfer machine learning system 102 may select the machine learning production model of the plurality of machine learning production models based on the distribution analysis.

In some non-limiting embodiments or aspects, the plurality of machine learning production models may include a first machine learning production model associated with a high confidence score, a second machine learning production model associated with a medium confidence score, and a third machine learning production model associated with a low confidence score. In some non-limiting embodiments or aspects, when selecting the machine learning production model of the plurality of machine learning production models, transfer machine learning system 102 may determine whether the confidence score of the input corresponds to a high confidence score, a medium confidence score, or a low confidence score. Transfer machine learning system 102 may select the first machine learning production model associated with a high confidence score, the second machine learning production model associated with a medium confidence score, or the third machine learning production model associated with a low confidence score based on determining whether the confidence score of the input corresponds to a high confidence score, a medium confidence score, or a low confidence score.

In some non-limiting embodiments or aspects, the first machine learning production model associated with the high confidence score may be capable of a fast runtime performance and a high accuracy when compared to the other machine learning production models of the plurality of machine learning production models. In some non-limiting embodiments or aspects, the second machine learning production model associated with the medium confidence score may be capable of a balanced runtime performance and a balanced accuracy when compared to the other machine learning production models of the plurality of machine learning production models. In some non-limiting embodiments or aspects, the third machine learning production model associated with a low confidence score may be capable of processing more difficult predictions (e.g., with low confidence scores).

In some non-limiting embodiments or aspects, transfer machine learning system 102 may determine one or more groupings of confidence scores (e.g., buckets) including, but not limited to, high confidence scores, medium confidence scores, and low confidence scores, based on the plurality of threshold values. For example, transfer machine learning system 102 may determine a first group of confidence scores (e.g., a group of high confidence scores) based on the high confidence scores being equal to or less than a first threshold of 1.0 and based on the high confidence scores exceeding a second threshold of 0.5. Transfer machine learning system 102 may determine a second group of confidence scores (e.g., a group of medium confidence scores) based on the medium confidence scores being equal to or less than the second threshold of 0.5 and based on the medium confidence scores exceeding a third threshold of 0.3. Transfer machine learning system 102 may determine a third group of confidence scores (e.g., a group of low confidence scores) based on the low confidence scores being equal to or less than the third threshold of 0.3 and based on the low confidence scores exceeding a fourth threshold of 0.0. It should be appreciated that any conceivable grouping scheme based on a plurality of threshold values is contemplated by the disclosed subject matter and the grouping scheme is not limited to high, medium and, low groupings of confidence scores and may use any number and value of threshold values.

In some non-limiting embodiments or aspects, transfer machine learning system 102 may determine the one or more groupings of confidence scores based on one or more machine learning algorithms and/or a distribution analysis. For example, transfer machine learning system 102 may determine the one or more groupings of confidence scores based on a k-means clustering algorithm. In some non-limiting embodiments or aspects, transfer machine learning system 102 may select a machine learning production model of a plurality of machine learning production models based on transfer machine learning system 102 determining the one or more groupings of confidence scores. For example, when selecting the machine learning production model of the plurality of machine learning production models, transfer machine learning system 102 may perform a distribution analysis based on a confidence score to determine a grouping for the confidence score. Transfer machine learning system 102 may then select the machine learning production model of the plurality of machine learning production models based on the distribution analysis and/or based on determining the grouping for the confidence score.

In some non-limiting embodiments or aspects, when determining the one or more groupings of confidence scores, transfer machine learning system 102 may determine the plurality of threshold values based on the k-means clustering algorithm. For example, transfer machine learning system 102 may determine each threshold value of the plurality of threshold values based on each mean (e.g., center, centroid) of each cluster (e.g., each cluster of confidence scores) of a plurality of clusters determined by the k-means clustering algorithm. In some non-limiting embodiments or aspects, transfer machine learning system 102 may determine the one or more groupings of confidence scores based on a process including testing and/or optimization based on a cross-validation technique.

In some non-limiting embodiments or aspects, transfer machine learning system 102 may train each machine learning production model of the plurality of machine learning production models based on at least one other machine learning production model of the plurality of machine learning production models as each machine learning production model may be a peer of each other machine learning production models of the plurality of machine learning production models. For example, the first machine learning production model may learn the dynamics and patterns of the second machine learning production model which may have been determined by training the second machine learning production model based on the second segment of data. In this way, transfer machine learning system 102 may improve the accuracy of predictions at inference based on transfer learning.

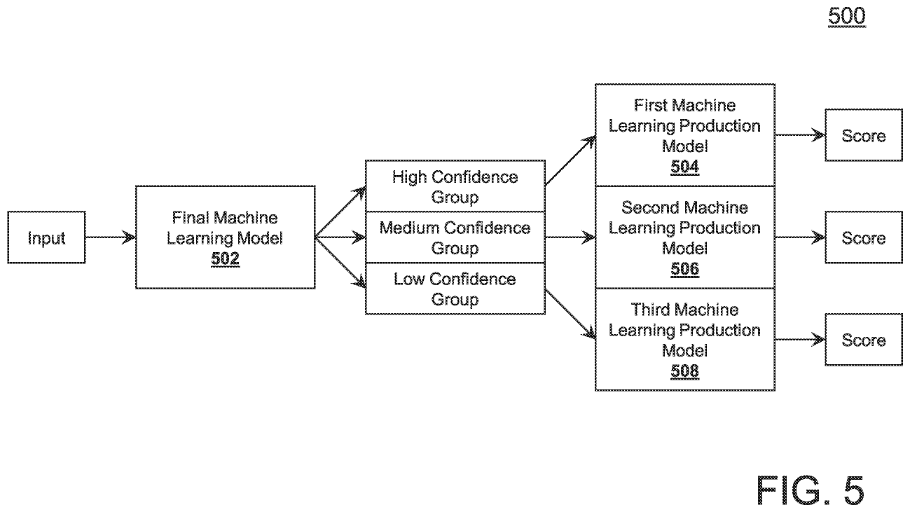

Referring now to FIG. 5, FIG. 5 is a diagram of a non-limiting embodiment of an implementation 500 of a transfer machine learning system (e.g., transfer machine learning system 102) at inference. In some non-limiting embodiments or aspects, implementation 500 may include final machine learning model 502, first machine learning production model 504, second machine learning production model 506, and third machine learning production model 508. In some non-limiting embodiments or aspects, final machine learning model 502, first machine learning production model 504, second machine learning production model 506, and/or third machine learning production model 508 may be a component of (e.g., part of) transfer machine learning system 102. In some non-limiting embodiments or aspects, final machine learning model 502, first machine learning production model 504, second machine learning production model 506, and/or third machine learning production model 508 may be separate from transfer machine learning system 102.

Final machine learning model 502 may include a confidence engine and/or a confidence machine learning model. Final machine learning model 502 may include a deep learning model that is trained based on transfer learning. In some non-limiting embodiments or aspects, final machine learning model 502 may be generated by transfer machine learning system 102 based on retraining the trained machine learning model using the augmented evaluation dataset. In some non-limiting embodiments or aspects, final machine learning model 502 may be used at inference (e.g., at runtime).

In some non-limiting embodiments or aspects, final machine learning model 502 (e.g., final machine learning model 502 of transfer machine learning system 102) may receive an input (e.g., an input at inference, an input at runtime, and/or the like). In some non-limiting embodiments or aspects, final machine learning model 502 may determine a confidence score for the input (e.g., based on the input). Transfer machine learning system 102 may generate the confidence score as an output of final machine learning model 502. In some non-limiting embodiments or aspects, transfer machine learning system 102 may select a machine learning production model of a plurality of machine learning production models (e.g., first machine learning production model 504, second machine learning production model 506, and/or third machine learning production model 508) based on the confidence score for the input determined by final machine learning model 502.

In some non-limiting embodiments or aspects, when selecting the machine learning production model of the plurality of machine learning production models, transfer machine learning system 102 may compare the confidence score for the input to a plurality of threshold values. In some non-limiting embodiments or aspects, transfer machine learning system 102 may determine whether the confidence score for the input satisfies (e.g., exceeds, is equal to, is less than, and/or the like) one or more threshold values of the plurality of threshold values. In some non-limiting embodiments or aspects, transfer machine learning system 102 may determine one or more groupings of confidence scores (e.g., buckets) including, but not limited to, a high confidence group, a medium confidence group, and a low confidence group, based on the plurality of threshold values. In some non-limiting embodiments or aspects, transfer machine learning system 102 may group the confidence score for the input into the high confidence group, the medium confidence group, or the low confidence group based on determining whether the confidence score of the input satisfies the one or more threshold values of the plurality of threshold values. In some non-limiting embodiments or aspects, when selecting the machine learning production model of the plurality of machine learning production models, transfer machine learning system 102 may select the machine learning production model of the plurality of machine learning production models based on the one or more groupings of confidence scores (e.g., based on a high confidence group, a medium confidence group, and/or a low confidence group).

First machine learning production model 504, second machine learning production model 506, and/or third machine learning production model 508 may include a deep learning model. In some non-limiting embodiments or aspects, first machine learning production model 504, second machine learning production model 506, and/or third machine learning production model 508 may be trained based on transfer learning. In some non-limiting embodiments or aspects, first machine learning production model 504, second machine learning production model 506, and/or third machine learning production model 508 may learn dynamics and patterns from the other machine learning production models (e.g., segments of data of the plurality of segments of data associated with other levels of difficulty). In this way, transfer machine learning system 102 may achieve higher accuracy of predictions at inference based on transfer learning.

Although the present disclosure has been described in detail for the purpose of illustration based on what is currently considered to be the most practical and preferred embodiments or aspects, it is to be understood that such detail is solely for that purpose and that the present disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system comprising:
at least one processor programmed or configured to:
train a base machine learning model using a training dataset to generate a trained machine learning model, wherein the base machine learning model is configured to provide a confidence score, wherein the confidence score is a score indicating how sure it is that a machine learning production model will provide a correct prediction of an input at inference;
evaluate the trained machine learning model using an evaluation dataset, wherein when evaluating the trained machine learning model using the evaluation dataset, the at least one processor is programmed or configured to:
generate a confidence score for each data instance of the evaluation dataset with the trained machine learning model;
augment the evaluation dataset based on the confidence score for each data instance of the evaluation dataset to generate an augmented evaluation dataset; and
retrain the trained machine learning model using the augmented evaluation dataset to generate a final machine learning model.

2. The system of claim 1, wherein each data instance of the evaluation dataset comprises at least one feature value and a ground truth value, wherein, when generating the confidence score for each data instance of the evaluation dataset with the trained machine learning model, the at least one processor is programmed or configured to:
determine a score of the trained machine learning model for each data instance of the evaluation dataset; and
calculate the confidence score for each data instance of the evaluation dataset based on the score of the trained machine learning model for each data instance of the evaluation dataset and the ground truth value for each data instance of the evaluation dataset.

3. The system of claim 2, wherein, when calculating the confidence score for each data instance of the evaluation dataset, the at least one processor is programmed or configured to:
calculate an absolute value of a difference of the ground truth value and the score of the trained machine learning model; and
subtract the absolute value of a difference of the ground truth value and the score of the trained machine learning model from 1 to provide the confidence score.

4. The system of claim 1, wherein each data instance of the evaluation dataset comprises at least one feature value and a ground truth value and wherein, when augmenting the evaluation dataset, the at least one processor is programmed or configured to:
replace the ground truth value for each data instance of the evaluation dataset with the confidence score for each data instance in the evaluation dataset to provide the augmented evaluation dataset.

5. The system of claim 1, wherein the at least one processor is further programmed or configured to:
receive an input;
determine a confidence score for the input; and
select a machine learning production model of a plurality of machine learning production models based on the confidence score for the input.

6. The system of claim 5, wherein, when selecting the machine learning production model of the plurality of machine learning production models, the at least one processor is programmed or configured to:
compare the confidence score of the input to a plurality of threshold values;
determine whether the confidence score of the input satisfies one or more of the plurality of threshold values; and
select the machine learning production model of the plurality of machine learning production models based on determining that the confidence score satisfies one or more of the plurality of threshold values.

7. The system of claim 5, wherein, when selecting the machine learning production model of the plurality of machine learning production models, the at least one processor is programmed or configured to:
perform a distribution analysis based on the confidence score of the input; and
select the machine learning production model of the plurality of machine learning production models based on the distribution analysis.

8. The system of claim 5, wherein the plurality of machine learning production models comprises a first machine learning production model associated with a high confidence score, a second machine learning production model associated with a medium confidence score, and a third machine learning production model associated with a low confidence score, and wherein, when selecting the machine learning production model of the plurality of machine learning production models, the at least one processor is programmed or configured to:
determine whether the confidence score of the input corresponds to the high confidence score, the medium confidence score, or the low confidence score; and
select the first machine learning production model associated with the high confidence score, the second machine learning production model associated with the medium confidence score, or the third machine learning production model associated with the low confidence score based on determining whether the confidence score of the input corresponds to the high confidence score, the medium confidence score, or the low confidence score.

9. A computer-implemented method comprising:
training, with at least one processor, a base machine learning model using a training dataset to generate a trained machine learning model, wherein the base machine learning model is configured to provide a confidence score, wherein the confidence score is a score indicating how sure it is that a machine learning production model will provide a correct prediction of an input at inference;
evaluating, with the at least one processor, the trained machine learning model using an evaluation dataset, wherein evaluating the trained machine learning model using the evaluation dataset comprises:
generating a confidence score for each data instance of the evaluation dataset with the trained machine learning model;
augmenting, with the at least one processor, the evaluation dataset based on the confidence score for each data instance of the evaluation dataset to generate an augmented evaluation dataset; and
retraining, with the at least one processor, the trained machine learning model using the augmented evaluation dataset to generate a final machine learning model.

10. The computer-implemented method of claim 9, wherein each data instance of the evaluation dataset comprises at least one feature value and a ground truth value, wherein generating the confidence score for each data instance of the evaluation dataset with the trained machine learning model comprises:
determining a score of the trained machine learning model for each data instance of the evaluation dataset; and
calculating the confidence score for each data instance of the evaluation dataset based on the score of the trained machine learning model for each data instance of the evaluation dataset and the ground truth value for each data instance of the evaluation dataset.

11. The computer-implemented method of claim 10, wherein calculating the confidence score for each data instance of the evaluation dataset comprises:
calculating an absolute value of a difference of the ground truth value and the score of the trained machine learning model; and
subtracting the absolute value of a difference of the ground truth value and the score of the trained machine learning model from 1 to provide the confidence score.

12. The computer-implemented method of claim 9, wherein each data instance of the evaluation dataset comprises at least one feature value and a ground truth value and wherein augmenting the evaluation dataset comprises:
replacing the ground truth value for each data instance of the evaluation dataset with the confidence score for each data instance in the evaluation dataset to provide the augmented evaluation dataset.

13. The computer-implemented method of claim 9, further comprising:
receiving, with the at least one processor, an input;
determining, with the at least one processor, a confidence score for the input; and
selecting, with the at least one processor, a machine learning production model of a plurality of machine learning production models based on the confidence score for the input.

14. The computer-implemented method of claim 13, wherein selecting the machine learning production model of the plurality of machine learning production models comprises:
comparing the confidence score of the input to a plurality of threshold values;
determining whether the confidence score of the input satisfies one or more of the plurality of threshold values; and
selecting the machine learning production model of the plurality of machine learning production models based on determining that the confidence score satisfies one or more of the plurality of threshold values.

15. The computer-implemented method of claim 13, wherein selecting the machine learning production model of the plurality of machine learning production models comprises:
performing a distribution analysis based on the confidence score of the input; and
selecting the machine learning production model of the plurality of machine learning production models based on the distribution analysis.

16. A computer program product comprising at least one non-transitory computer readable medium including one or more instructions that, when executed by at least one processor, cause the at least one processor to:
train a base machine learning model using a training dataset to generate a trained machine learning model, wherein the base machine learning model is configured to provide a confidence score, wherein the confidence score is a score indicating how sure it is that a machine learning production model will provide a correct prediction of an input at inference;
evaluate the trained machine learning model using an evaluation dataset, wherein the one or more instructions that cause the at least one processor to evaluate the trained machine learning model using the evaluation dataset cause the at least one processor to:
generate a confidence score for each data instance of the evaluation dataset with the trained machine learning model;
augment the evaluation dataset based on the confidence score for each data instance of the evaluation dataset to generate an augmented evaluation dataset; and
retrain the trained machine learning model using the augmented evaluation dataset to generate a final machine learning model.

17. The computer program product of claim 16, wherein each data instance of the evaluation dataset comprises at least one feature value and a ground truth value, wherein the one or more instructions that cause the at least one processor to generate the confidence score for each data instance of the evaluation dataset with the trained machine learning model cause the at least one processor to:
determine a score of the trained machine learning model for each data instance of the evaluation dataset; and
calculate the confidence score for each data instance of the evaluation dataset based on the score of the trained machine learning model for each data instance of the evaluation dataset and the ground truth value for each data instance of the evaluation dataset.

18. The computer program product of claim 17, wherein the one or more instructions that cause the at least one processor to calculate the confidence score for each data instance of the evaluation dataset cause the at least one processor to:
calculate an absolute value of a difference of the ground truth value and the score of the trained machine learning model; and
subtract the absolute value of a difference of the ground truth value and the score of the trained machine learning model from 1 to provide the confidence score.

19. The computer program product of claim 16, wherein each data instance of the evaluation dataset comprises at least one feature value and a ground truth value and wherein the one or more instructions that cause the at least one processor to augment the evaluation dataset cause the at least one processor to:
replace the ground truth value for each data instance of the evaluation dataset with the confidence score for each data instance in the evaluation dataset to provide the augmented evaluation dataset.

20. The computer program product of claim 16, wherein the one or more instructions further cause the at least one processor to:
receive an input;
determine a confidence score for the input; and
select a machine learning production model of a plurality of machine learning production models based on the confidence score for the input.
